(19) United States
(12) Patent Application Publication
(10) Pub. No.: US 2009/0200109 A1
(43) Pub. Date: Aug. 13, 2009

(54) Energy Absorber

(76) Inventor: Simon Luke, Solihull (GB)

Correspondence Address: Ira S Dorman, 330 Roberts Street, Suite 200, East Hartford, CT, 06108, US

(21) Appl. No.: 11/992,270

(22) PCT Filed: Sep. 15, 2006
(86) PCT No.: PCT/GB2006/003427

§ 371 Date: Mar. 30, 2009

(30) Foreign Application Priority Data
Sep. 23, 2005 (GB) 0519404.8

(51) Int. Cl. E04G 3/32; A62B 35/04

(52) U.S. Cl. 182/100; 24/134 R

(57) ABSTRACT

An energy absorber, for use with a safety cable attached to a structure, comprises an elongate slide member (3) and a friction plate (5, 7) positioned adjacent to the elongate slide member. The friction plate is urged against a face of the elongate slide member by a biasing means (9, 11) to generate friction between the friction plate and the elongate slide member.

This invention relates to an energy absorber, for example for use with a safety cable attached to a structure such as an electricity pylon and used in conjunction with a fall arrest device. However, it will be noted the energy absorber can be used in a vertical, horizontal or inclined configuration and on a variety of structures.

To ensure the safety of a person (user) climbing a structure, for example an electricity pylon, a safety system is used in which the user is attached to a safety cable by way of a fall arrest device which is movable along the cable. The safety cable is attached by a structural anchor in the region of the top of the structure.

In the event of a fall, the fall arrest device will lock onto the cable thereby arresting the fall of the user.

However, in the event of a fall, a relatively high load is applied to the structure and to the falling user via the attachment of the safety cable to the structure. The load at the structural anchor can be significantly higher than the load on the user, especially in multi-user fall situations.

An energy absorber is known in which a rod or the like of metal is pulled through a die to absorb energy by deformation of the metal in the event of a fall in order to minimise the load applied to the user and to the structure.

Such an energy absorber is adequate to absorb energy resulting from the fall of a single user. However, the known energy absorber is not adequate to minimise the load applied to the structure in a reliable and predictable manner in the event of several users falling at the same time.

There is a need for an energy absorber for use with a safety cable which minimises the load applied to a structure in the event of a fall of one or more users from the structure and which provides energy absorption in a reliable and predictable manner.

It is therefore an object of the present invention to provide an energy absorber which overcomes or minimises these problems.

According to the present invention there is provided an energy absorber, for use with a safety cable attached to a structure, the energy absorber comprising an elongate slide member and a friction plate positioned adjacent to the elongate slide member, wherein the friction plate is urged against a face of the elongate slide member by a biasing means to generate friction between the friction plate and the elongate slide member.

The friction plate may be of phosphor bronze.

A retaining member may be provided to retain the friction plate in position adjacent to the elongate slide member.

The retaining member may be adapted to connect the remainder of the energy absorber to a fixing bracket for attachment to the structure. Alternatively, the energy absorber may be attached directly to the structure.

Isolating material, adapted to minimise galvanic reaction, may be provided between the retaining member and the remainder of the energy absorber. The isolating material may be a plastics material, for example a hardwearing plastics material.

Retaining means, for example a shoulder, may be provided on the friction plate and adapted to retain the friction plate within the retaining member. The retaining member may be provided with an aperture configured to receive the retaining means of the friction plate.

The biasing means may be in the form of a spring, such as a coil spring.

The biasing means may be in the form of a pair of coaxially arranged springs with a second spring arranged coaxially within a first spring.

The biasing means may be positioned between the friction plate and an end plate. Adjusting means may be provided to adjust a spacing between the friction plate and the end plate to compress the biasing means to a predetermined length and/or torque.

At least one pair of friction plates may be provided wherein the friction plates are urged against opposite face of the elongate slide member by the biasing means. A plurality of pairs of friction plates may be provided.

The at least one pair of friction plates may be secured to each other by securing means passing through an elongate aperture in the elongate slide member. The elongate aperture may be linear or non-linear. A guide member, for example a cylindrical guide member, may extend through the elongate aperture to guide the friction plate along the slide member.

An aperture may be provided in an end of the elongate slide member to facilitate the attachment of a cable to the elongate slide member.

For a better understanding of the present invention and to show more clearly how it may be carried into effect reference will now be made, by way of example, to the accompanying drawings in which:

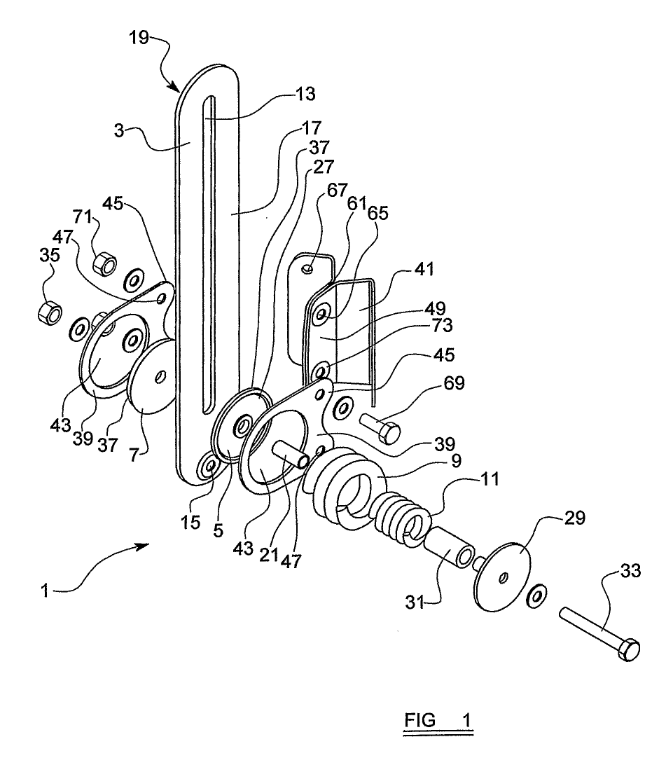

FIG. 1 is an exploded perspective view of a first embodiment of an energy absorber according to the present invention together with a fixing bracket;

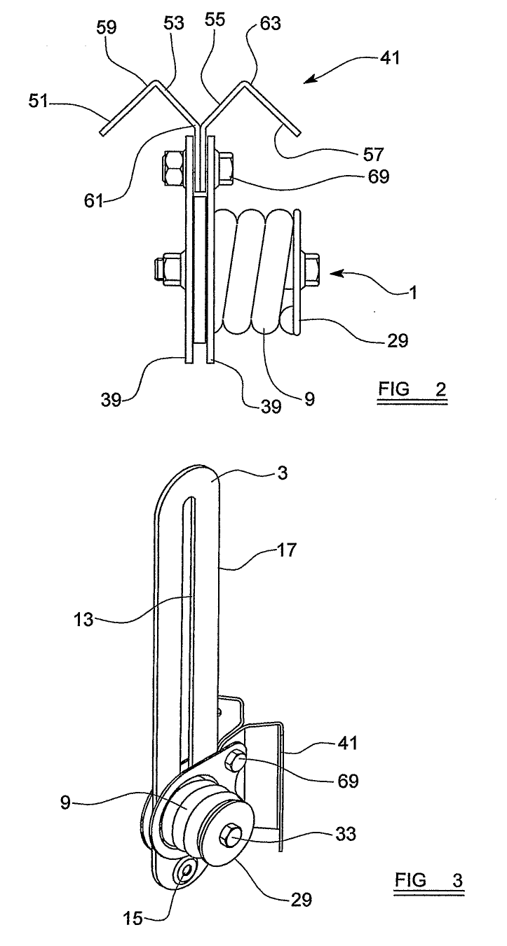

FIG. 2 is a plan view of the energy absorber shown in FIG. 1 attached to the fixing bracket;

FIG. 3 is a perspective view of the energy absorber shown in FIG. 1 attached to the fixing bracket;

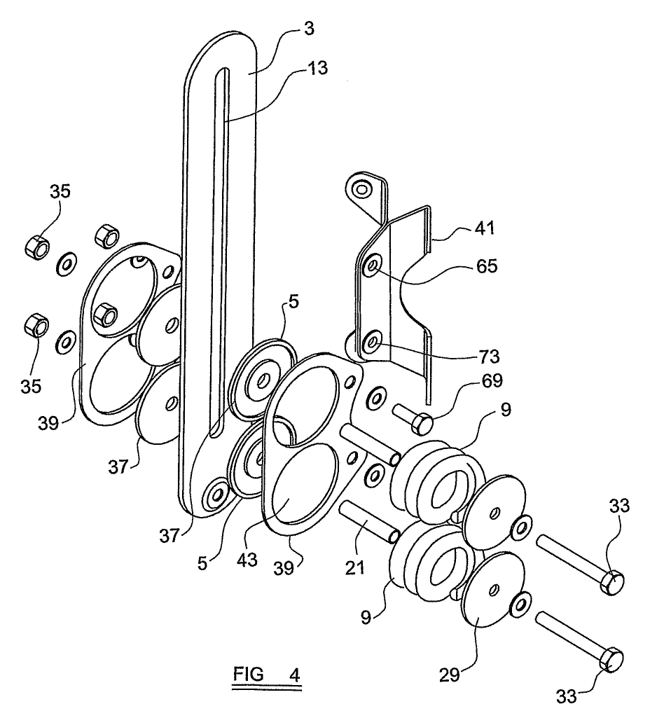

FIG. 4 is an exploded perspective view of a second embodiment of an energy absorber according to the present invention together with a fixing bracket;

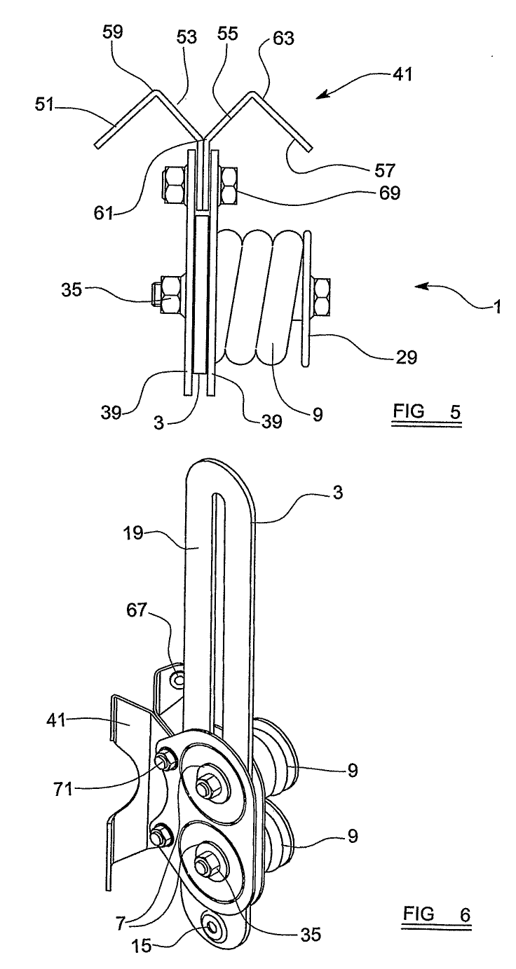

FIG. 5 is a plan view of the energy absorber shown in FIG. 4 attached to the fixing bracket; and

FIG. 6 is a perspective view of the energy absorber shown in FIG. 4 attached to the fixing bracket.

FIGS. 1 to 3 show a first embodiment of an energy absorber 1 according to the present invention for use on a structure, for example an electricity pylon. The energy absorber comprises an elongate plate-like slide member 3 and friction plates 5, 7 which are urged against the elongate slide member 3 by biasing means 9, 11.

The elongate slide member 3, preferably of 316 grade stainless steel, has an elongate slot 13, for example 100 mm in length, therethrough. The elongate slot 13 is within the elongate slide member 3 and extends along a longitudinal axis of the elongate slide member 3. A through hole 15 is provided adjacent to an end on the elongate slide member 3, lowermost in the figures, to provide a means of attaching the elongate slide member 3 to a cable (not shown), for example by means of a clevis. The elongate slot 13 could be linear or non-linear.

A first circular friction plate 5 is positioned against a first face 17 of the elongate slide member 3 and a second circular friction plate 7 is positioned against a second face 19 of the elongate slide member 3, the second face opposing the first face. The friction plates 5, 7 are preferably of phosphor bronze. A cylindrical peg 21 passes through a central hole in the first friction plate 5, through the elongate slot 13 in the elongate slide member 3 and through a central hole in the second friction plate 7 to secure the friction plates 5, 7 together.

Friction is created between first faces (nearest to the elongate slide member 3) of the friction plates 5, 7 and the elongate slide member 3 by first biasing means 9 in the form of a first stainless steel coil spring and by second biasing means 11 in the form of a second stainless steel coil spring, the springs 9, 11 being positioned between a second face 27 (furthest from the elongate slide member 3) of the first friction plate 5 and a circular end plate 29. The second spring is of smaller diameter than the first spring and is position coaxially within the first spring. The second, inner, spring is maintained in the coaxial position by means of a cylinder 31 which passes axially through the interior of the second spring 11.

A threaded securing means 33, in the form of an elongate bolt, passes through a central hole in the end plate 29, through the cylinder 31 within the second spring 11, through the peg 21 positioned through the elongate slot of the elongate slide member and between the first and second friction plates, and extends outwards therefrom. Consequently, the slot enables the elongate slide member to move slidably relative to the securing means 33 and the components mounted thereon.

A head on the securing means 33 prevents the securing means from passing completely through the hole in the end plate 29. A fastening means 35, for example a fastening nut, is threadingly attached to the portion of the securing means extending outwardly from the second friction plate 7 such that the coaxial springs 9, 11 are compressed between the second face of the first friction plate 5 and the circular end plate 29. Compression of the coaxial springs urges the first faces of the friction plates against the elongate slide member creating friction therebetween which resists relative movement between the friction plates 5, 7 and the elongate slide member 3.

Washers are positioned between the head of the securing means and the end plate 29, and between the second face of the second friction plate 7 and the fastening means 35.

The first face of each friction plate, adjacent to the elongate slide member 3, has a diameter greater than the opposing second face such that a shoulder 37 is provided around the circumference of the friction plate.

Plate-like retaining members 39 are provided either side of the elongate slide member 3 to connect the energy absorber to a fixing bracket 41 (as described hereinafter) by way of the friction plates 5,7. Each retaining member 39 has an aperture 43 with a diameter corresponding to the diameter of the second face of a friction plate. Consequently, each friction plate is retained within the aperture 43 of the retaining member 39 but is prevented from passing through the aperture in a direction away from the elongate slide member 3 by the circumferential shoulder 37 of the friction plate. Alternatively, the friction plate could be formed with an annular groove for seating the spring 9 and which would also prevent lateral movement of the friction plate.

Each retaining member 39 has a pair of protrusions 45, coplanar with the plane of the retaining member, the protrusions extending beyond an edge of the elongate slide member 3. A through hole 47 is provided in each protrusion 45. The positions of the through holes in one pair of protrusions correspond to complementary holes through the other pair of protrusions, that is each through hole in one pair of protrusions is coaxial with a corresponding through hole in the other pair of protrusions.

As shown in FIG. 2, the plate-like fixing bracket 41, referred to hereinbefore, is formed of two angled plates which together form an “M” shaped cross-section in which four plate-like arms 51, 53, 55, 57 are arranged to form three ridges 59, 61, 63. The length of each of the arms is substantially identical. The angle subtended at a ridge between two adjacent arms is substantially 90 degrees.

Each component of the bracket 41 is formed with an attachment member 49 which extends outwards from the ridge 61 formed between the two innermost arms 53, 55 of the fixing bracket 41 along the length of the ridge. The attachment member 49 is parallel, in use, to the longitudinal axis of the elongate slide member 3 of the energy absorber 1.

Through holes 65 are provided in the attachment members 49, the holes 65 being positioned to correspond to the position of the holes 47 through the protrusions 45 of the retaining members 39.

A pair of holes 67 is also provided through each of the two outermost arms 51, 57 of the fixing bracket 41 to enable the fixing bracket 41 to be secured around a portion of a pylon (not shown).

The first retaining member and the second retaining member of the energy absorber 1 are secured together, with one retaining member either side of the elongate slide member 3. The attachment members 49 of the fixing bracket 41 are positioned between the retaining members 39 and secured in position by securing means 69, preferably bolts. The securing means 69 passes through the holes 47 in the protrusions 45 of the retaining members and the holes 65 in the attachment members 49, and is fastened by fastening means 71, for example fastening nuts. Consequently, the energy absorber 1 is secured in position relative to the fixing bracket 41 attached to the portion of the pylon.

Pylons are generally galvanised and painted to avoid galvanic corrosion problems. In order further to reduce the risk of corrosion, the energy absorber 1 is isolated from the pylon by means of isolating bushes 73 provided through the holes in the attachment members 49 of the fixing bracket 41 to minimise the possibility of a galvanic reaction between the pylon and the energy absorber 1. The isolating bushes 73 are made of DELRIN, an insulating Nylon-type polymer which is hardwearing and resistant to UV degradation, or an equivalent material.

In use, the fixing bracket 41 is positioned at the top of a pylon. Adjacent faces of the innermost arms 53, 55 of the fixing bracket 41 are positioned against a portion of a strut of the pylon. The fixing bracket 41 is secured in position relative to the strut of the pylon by securing means passing through the holes provided through each of the two outermost arms 51, 57 of the fixing bracket 41 and passing around the body of the strut as it is not permissible to drill fixing holes in the struts of the pylon. Other means of clamping to the pylon or structure could be used.

Once the fixing bracket 41 is secured to the pylon, the energy absorber 1 is attached to the fixing bracket 41 by the securing means 69 passing through the retaining members 39 and the attachment members 49 of the fixing bracket 41 as described hereinbefore.

The friction plates 5, 7 are urged against the elongate slide member 3 of the energy absorber 1 by tightening the fastening means 35 threadingly attached to the portion of the securing means 33 extending outwardly from the second friction plate 7 until a predetermined compression of the coaxial springs 9, 11 is achieved between the second face 27 of the first friction member and the end plate 29. As the spring constant is known, the predetermined compression can be achieved by rotating the fastening means relative to the thread of the securing means until a predetermined length of spring is achieved. Shims may be used to determine the length of the springs 9, 11 when compressed in order that the predetermined length can be achieved.

Alternatively, the predetermined compression could be achieved by rotating the fastening means relative to the thread of the securing means until a predetermined value of torque is achieved.

A safety cable is attached to the through hole 15 provided adjacent to the end on the elongate slide member 3 as described hereinbefore. The cable is connected to a tensioning unit (not shown) attached to a lower portion of the pylon situated at a relatively short distance from the ground on which the pylon is positioned. The tensioning unit is adapted to tension the cable with a predetermined tensioning force of, for example, 1 kN. Consequently a tensioned cable, to which a user can attach himself, extends down the pylon.

In the event of the user falling while at a height on the pylon, the user, via the attachment to the tensioned cable, will exert a downward force on the lowermost region of the elongate slide member 3 of the energy absorber 1 as the safety cable is deflected from a rest position. The elongate slide member will pivot about a longitudinal axis of the coaxial springs 9, 11 such that the longitudinal axis of the elongate slot 13 is parallel to the downward direction of the applied force.

Due to the predetermined compression of the springs 9, 11 and the friction plates 5, 7 being urged against the elongate slide member 3, the rate of sliding movement of the elongate slide member 3 relative to the friction plates will be reduced in a predictable manner by the friction. Consequently energy created by the fall of the user is converted into energy to overcome the friction between the friction plates and the elongate slide member 3 so absorbing energy which may otherwise have been transferred to the pylon and the user.

The length and form of the elongate slot 13 in the elongate slide member 3 and the predetermined compression of the springs are selected so as to reduce the force when arresting a falling user to less than 6 kN.

It should be appreciated that the inner spring 9 could be positioned within the outer spring 11 by a relatively short locating cylindrical member provided at each end of the inner spring 9 to align the springs relative to each other rather than by the central cylinder 31 described hereinbefore.

Different springs could be used if it was desirable to absorb energy at different rates.

It should further be appreciated that the length of the elongate slot 13 in the elongate slide member 3 could be greater than 100 mm if a greater mass, for example a number of users, was to be attached to the energy absorber 1 or springs with different spring constants could be used if it was desirable to absorb energy at different rates.

Although, it has been described hereinbefore that the energy absorber 1 is attached to the fixing bracket 41 by a securing means 39 passing through the attachment members 49 of the fixing bracket 41, the energy absorber 1 could be fastened to the fixing bracket 41 or by any other suitable fixing means.

FIGS. 4 to 6 show a second embodiment of an energy absorber 1 in accordance with the present invention in which two sets of circular friction plates 5, 7 are provided. The two sets of friction plates are arranged adjacent to each other along the longitudinal axis of the elongate slide member.

Similar features to those in the first embodiment have been given corresponding reference numbers.

The arrangement of two sets of friction plates urged against the elongate slide member increases the friction that can be produced and/or provides more surface area between which friction can be generated.

As can be seen in FIG. 4, a single spring 9 is provided between a first friction plate 5 and an end plate 29 for each set of friction plates. However it should be appreciated that a coaxial arrangement of two springs could be used as shown in FIGS. 1 to 3. The advantage of the coaxial spring arrangement is that it provides a greater spring force in a given area.

The retaining members are provided with a pair of apertures, arranged parallel to the longitudinal axis of the elongate slide member, to accommodate the presence of two sets of friction plates.

The energy absorber 1 shown in FIGS. 4 to 6 is mounted on a pylon, and used, as explained for the energy absorber shown in FIGS. 1 to 3.

It should be appreciated that the energy absorber 1 shown in FIGS. 4 to 6 could incorporate additional features from the energy absorber shown in FIGS. 1 to 3.

An energy absorber in accordance with the present invention could be provided with a casing, for example a weather-resistant casing, to protect the components of the energy absorber from the environment. An aperture would be provided in a lower region of the casing to permit the safety cable attached to the through hole 15 of the elongate slide member 3 to be connected to the tensioning unit attached to a lower portion of the structure. The aperture would also be dimensioned to permit the lowermost end of the elongate slide member to exit the casing in the event of a user falling whilst attached to the tensioned cable.

1. An energy absorber comprising:
a friction plate (5, 7);
a substantially planar elongate member (3) slidably mounted relative to the friction Plate (5, 7):
biasing means (9, 11) in the form of a spring urging the friction plate against the elongate member so as to create friction between the friction plate and the elongate member; and
means for adjusting compression of the spring (9, 11) so as to apply a predetermined compressive force of the friction plate against the elongate member.

2. An energy absorber as claimed in claim 1, wherein the friction plate (5, 7) is of phosphor bronze.

3. An energy absorber as claimed in claim 1, wherein a retaining member (39) is provided to retain the friction plate (5, 7) in position adjacent to the elongate member (3).

4. An energy absorber as claimed in claim 3, wherein the retaining member (39) is adapted to connect the remainder of the energy absorber to a fixing bracket for attachment to the structure.

5. An energy absorber as claimed in claim 3, wherein isolating material (73), adapted to minimise galvanic reaction, is provided between the retaining member (39) and the remainder of the energy absorber.

6. An energy absorber as claimed in claim 5, wherein the isolating material (73) is a plastics material.

7. An energy absorber as claimed in claim 6, wherein the isolating material (73) is a hardwearing plastics material.

8. An energy absorber as claimed in claim 3, wherein retaining means (37) is provided on the friction plate (5, 7) and adapted to retain the friction plate within the retaining member (39).

9. An energy absorber as claimed in claim 8, wherein the retaining means (37) comprises a shoulder.

10. An energy absorber as claimed in claim 8, wherein the retaining member (39) is provided with an aperture (43) configured to receive the retaining means (37) of the friction plate (5, 7).

11. (canceled)

12. An energy absorber as claimed in claim 1, wherein the biasing means (9, 11) is in the form of a coil spring.

13. An energy absorber as claimed in claim 1, wherein the biasing means (9, 11) is in the form of a pair of coaxially arranged springs with a second spring (11) arranged coaxially within a first spring (9).

14. An energy absorber as claimed in claim 1, wherein the biasing means (9, 11) is positioned between the friction plate (5, 7) and an end plate (29).

15. An energy absorber as claimed in claim 14, wherein adjusting means (35) is provided to adjust a spacing between the friction plate (5, 7) and the end plate (29) to compress the biasing means (9, 11) to a predetermined length and/or torque.

16. An energy absorber as claimed in claim 1, wherein at least one pair of friction plates (5, 7) is provided and wherein the friction plates are urged against opposite faces of the elongate member (3) by the biasing means (9, 11).

17. An energy absorber as claimed in claim 16, wherein a plurality of pairs of friction plates (5, 7) are provided.

18. An energy absorber as claimed in claim 16, wherein the at least one pair of friction plates (5, 7) is secured to each other by securing means (21) passing through an elongate aperture (13) in the elongate member (3).

19. An energy absorber as claimed in claim 18, wherein the elongate aperture (13) is linear.

20. An energy absorber as claimed in claim 18, wherein the elongate aperture (13) is non-linear.

21. An energy absorber as claimed in claim 18, wherein a guide member (21) extends through the elongate aperture (13) to guide the friction plate (5, 7) along the elongate member (3).

22. An energy absorber as claimed in claim 21, wherein the guide member (21) comprises a cylindrical member.

23. An energy absorber as claimed in claim 1, wherein an aperture (15) is provided in an end of the elongate member (3) to facilitate the attachment of a cable to the elongate member.
